(19) United States
(12) Patent Application Publication
(10) Pub. No.: US 2010/0087131 A1
(43) Pub. Date: Apr. 8, 2010

(54) Integrated air supply device

(76) Inventors: Joerg Stuetzer, Burgrieden (DE); Johannes Winkler, Staig (DE); Andreas Becker, Opfingen (DE)

Correspondence Address: KRIEG DEVAULT LLP, ONE INDIANA SQUARE, SUITE 2800, INDIANAPOLIS, IN, 46204-2079, US

(21) Appl. No.: 12/566,414

(22) Filed: Sep. 24, 2009

Related U.S. Application Data
(60) Provisional application No. 61/099,627, filed on Sep. 24, 2008.

(30) Foreign Application Priority Data
Sep. 24, 2008 (DE) 10 2008 048 743.0

(51) Int. Cl. B64D 13/00

(52) U.S. Cl. 454/76

(57) ABSTRACT

An air supply device (10) for supplying conditioned air into an aircraft passenger cabin comprises an air duct (12) with an air inlet (18), which is connectable to a line system of an aircraft air conditioning system in order to supply conditioned air provided by the aircraft air conditioning system to the air duct (12), and with an air outlet (20), which is connectable to an interior of the aircraft passenger cabin in order to convey the conditioned air supplied to the air duct (12) by the aircraft air conditioning system into the interior of the aircraft passenger cabin. In at least a first portion (14) of the air duct (12) a first boundary wall (24) of the air duct (12) is formed by a portion of a luggage compartment housing back wall (26).

### CROSS REFERENCE TO RELATED APPLICATIONS

The present application claims priority to German Patent Application No. 10 2008 048 743.0, filed Sep. 24, 2008 and claims the benefit of U.S. Provisional Patent Application No. 61/099,627, filed Sep. 24, 2008, each of which is incorporated herein by reference.

The invention relates to an air supply device for supplying conditioned air into an aircraft passenger cabin.

An aircraft air conditioning system comprises a series of air supply devices, to which air flowing through a line system of the aircraft air conditioning system is supplied through an air inlet. The air supply devices are used to connect the line system of the aircraft air conditioning system to corresponding air outlet openings that are provided in the region of the passenger cabin of the aircraft. In modern commercial aircraft the air outlet openings for supplying conditioned air into the passenger cabin are conventionally disposed in the foot space of the passenger cabin and/or in the region of the luggage compartments fitted above the rows of seats. Particularly in the case of air supply devices that are used to supply conditioned air from the aircraft air conditioning system to air outlet openings disposed in the region of the luggage compartments, there is the problem that it is often difficult to integrate air supply devices having a sufficiently large cross section of flow into the limited installation space at the rear side of the luggage compartments facing away from the interior of the passenger cabin.

From DE 10 2007 030 331 and PCT/EP2008/058275 in each case an aircraft luggage compartment is known, which has a housing, in which a personal service duct as well as an air line are integrated.

The present invention is directed to the object of providing an air supply device for supplying conditioned air into an aircraft passenger cabin, which device is of a compact and installation-space-saving construction and is suitable to be disposed at the rear side—facing away from an interior of the passenger cabin—of luggage compartments provided in the passenger cabin.

In order to achieve this object, an air supply device according to the invention for supplying conditioned air into an aircraft passenger cabin comprises an air duct with an air inlet, which is connectable to a line system of an aircraft air conditioning system in order to supply conditioned air provided by the aircraft air conditioning system to the air duct. An air outlet of the air supply device according to the invention is connectable to an interior of the aircraft passenger cabin in order to convey the conditioned air supplied to the air duct by the aircraft air conditioning system into the interior of the aircraft passenger cabin. In the fitted state of the air supply device in an aircraft, the air outlet of the air duct is disposed preferably above the rows of seats in the region of overhead luggage compartments provided in the passenger cabin. In at least a first portion of the air duct a first boundary wall of the air duct is formed by a portion of a luggage compartment housing back wall. Here, by “a luggage compartment housing back wall” is meant a wall of a luggage compartment housing that, in the fitted state of the luggage compartment housing in an aircraft cabin, faces away from an interior of the aircraft cabin.

In the case of the air supply device according to the invention it is possible in the first portion of the air duct to dispense with an additional component for forming the first boundary wall of the air duct. The air duct is therefore of a particularly compact and lightweight construction, with the result that the air supply device according to the invention allows optimum utilization of the limited installation space in the region of the luggage compartment housing back wall. By virtue of the optimum utilization of the installation space the air supply device according to the invention may have, in the region of the first air duct portion and in particular of the air outlet, a cross section of flow that is large enough to allow the supply of a required air volume flow into the passenger cabin at an air injection speed that is comfortable for the passengers and without increased noise generation.

Preferably, in the first portion of the air duct a second boundary wall of the air duct is formed by a portion of a personal service duct. The personal service duct and the luggage compartment housing and/or the luggage compartment housing back wall preferably take the form of separate components. The personal service duct may be used for example to receive components such as for example an individual air supply device, reading lamps, loudspeakers, oxygen masks and the like. For example, the portion of the personal service duct forming the second boundary wall of the first air duct portion may be disposed opposite the portion of the luggage compartment housing back wall forming the first boundary wall. A first air duct portion, which comprises not only a first boundary wall formed by a portion of the luggage compartment housing back wall but also a second boundary wall formed by a personal service duct portion, is particularly lightweight and compact.

The luggage compartment housing back wall portion forming the first boundary wall of the first air duct portion and the personal service duct portion forming the second boundary wall of the first air duct portion are preferably shaped in such a way that the air flow through the first air duct portion may be controlled in the desired manner. In particular, the luggage compartment housing back wall portion forming the first boundary wall of the first air duct portion and the personal service duct portion forming the second boundary wall of the first air duct portion are shaped in such a way that the air at the air outlet of the air duct is blown out in the direction of a closed flap of the luggage compartment and flows along the flap. This allows a draught-free supply of air to the passengers in the aircraft cabin. The luggage compartment housing back wall and the personal service duct preferably take the form of honeycomb components. This has the advantage that these two components then already possess an insulating function, thereby making it possible to dispense with additional insulating elements for insulating the first air duct portion.

In the first portion of the air duct a third boundary wall of the air duct is preferably formed by a first covering cap. The first covering cap may extend for example substantially at right angles to the luggage compartment housing back wall portion forming the first boundary wall of the first air duct portion and/or substantially at right angles to the personal service duct portion forming the second boundary wall of the first air duct portion. Preferably, the first covering cap is connected to the luggage compartment housing back wall portion forming the first boundary wall of the first air duct portion and to the personal service duct portion forming the second boundary wall of the first air duct portion and therefore forms a lateral boundary of the first air duct portion.

In a similar manner, in the first portion of the air duct a fourth boundary wall may be formed by a second covering cap. The second covering cap may extend substantially at right angles to the luggage compartment housing back wall portion forming the first boundary wall of the first air duct portion and/or substantially at right angles to the personal service duct portion forming the second boundary wall of the first air duct portion. In a similar manner to the first covering cap, the second covering cap is also preferably connected both to the luggage compartment housing back wall portion forming the first boundary wall of the first air duct portion and to the personal service duct portion forming the second boundary wall of the first air duct portion and therefore forms a lateral boundary of the first air duct portion. The first covering cap and the second covering cap are preferably disposed opposite one another.

In a second portion the air duct of the air supply device according to the invention may be formed by an air guide element. The second portion of the air duct is preferably disposed, in relation to the direction of flow of the conditioned air flowing through the air duct, upstream of the first portion of the air duct. The air guide element forming the second air duct portion may be a component formed separately from the luggage compartment housing and may comprise a connecting piece for the connection to the line system of the aircraft air conditioning systems. The air guide element therefore facilitates the connection of the air supply device according to the invention to the line system of the aircraft air conditioning system. The air guide element of the air supply device according to the invention is preferably fastened to the luggage compartment housing back wall and/or to the personal service duct. The air guide element may then be preassembled with the luggage compartment housing back wall or the luggage compartment housing and/or the personal service duct into a subassembly that may be handled independently. It is therefore possible to dispense with a separate fastening of the air guide element to the aircraft structure. This not only makes it possible to dispense with structural supports and hence save weight and installation space but also facilitates the assembly of the air supply device in an aircraft.

In the first portion of the air duct a flow control element may be disposed. Preferably, the flow control element is situated in the region of the air outlet of the air duct.

The flow control element may comprise for example an aperture, which effects a holdup of the air flowing through the air duct and is therefore used to control the distribution of the air flow exiting from the air outlet of the air duct. With regard to its shape, the aperture is adapted to a cross section of the air outlet of the air duct. For example, the aperture may have a plate surface, in which is disposed a plurality of openings that are distributed over the plate surface. The shape and the size of the openings provided in the plate surface may be adapted to the demands placed on the distribution of the air flow exiting from the air outlet.

The flow control element of the air supply device according to the invention may further comprise guide vanes that extend, in relation to the direction of flow of the conditioned air flowing through the air duct, downstream of the aperture. The guide vanes straighten out the air flow exiting from the air outlet of the air duct and hence optimize the air distribution along the air outlet.

The guide vanes are preferably shaped and mutually spaced apart in such a way that they serve as protection against intrusion into the air outlet of the air duct. In other words, the mutual spacing of the guide vanes is so narrow that it is impossible to reach into the air duct. Guide vanes serving as intrusion protection are preferably designed without sharp edges and/or corners to minimize any risk of injury.

In the region of the air outlet of the air duct a masking element may be disposed. The masking element may for example take the form of a honeycomb panel and have an opening, the shape and size of which are adapted to the cross section of the air outlet of the air duct. The masking element may be fastened to a flange formed on the flow control element. Preferably, the masking element is fastened in a detachable manner to allow the masking element, in the event of a reconfiguration of the aircraft cabin fittings, to be exchanged for example for a masking element without an opening.

There now follows a detailed description of a preferred embodiment of the invention with reference to the accompanying diagrammatic drawings, which show:

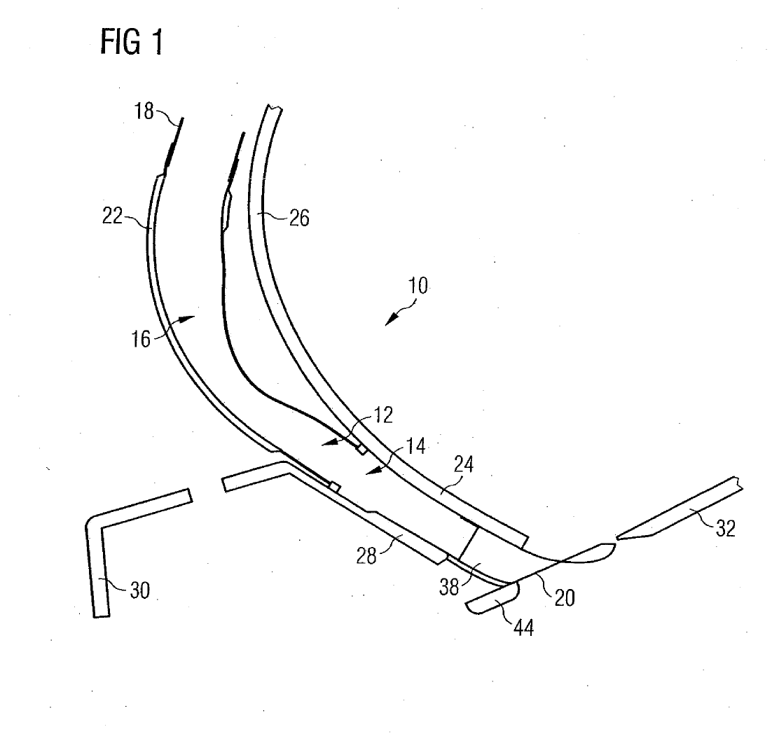

FIG. 1 a cross section of an air supply device for supplying conditioned air into an aircraft passenger cabin,

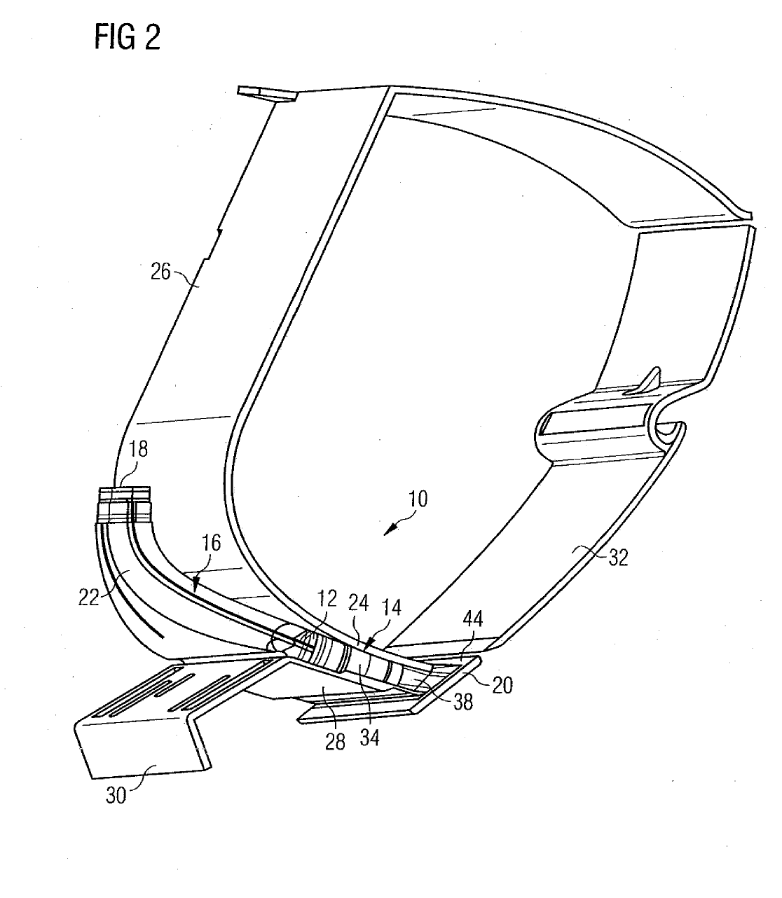

FIG. 2 a three-dimensional view of the air supply device according to FIG. 1 and

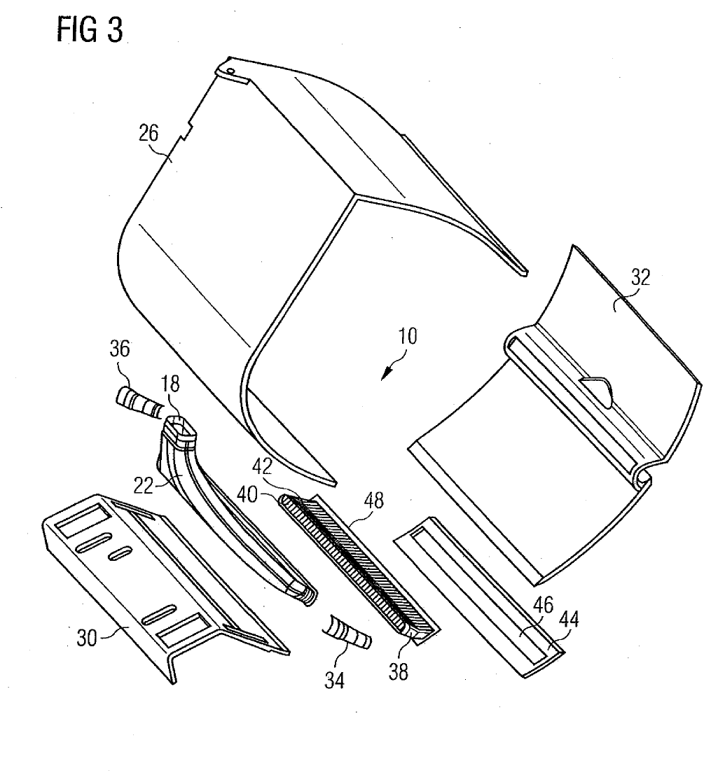

FIG. 3 a three-dimensional exploded view of the air supply device according to FIG. 1.

An air supply device 10 shown in FIGS. 1 to 3 comprises an air duct 12 having a first portion 14 and a second portion 16. The second portion 16 of the air duct 12 has an air inlet 18, while the first portion 14 of the air duct 12 is provided with an air outlet 20. The air inlet 18 of the air duct 12 is connectable to a line system of an aircraft air conditioning system in order to allow conditioned air provided by the aircraft air conditioning system to be supplied through the air inlet 18 to the air duct 12. The air outlet 20 of the air duct 12, on the other hand, is connectable to an interior of an aircraft passenger cabin in order to convey the conditioned air supplied to the air duct 12 by the aircraft air conditioning system into the interior of the aircraft passenger cabin. In relation to the direction of flow of the conditioned air flowing through the air duct 12, the first portion 14 of the air duct 12 is therefore disposed downstream of the second portion 16 of the air duct 12.

The second portion 16 of the air duct 12 is formed by an air guide element 22. The first portion 14 of the air duct 12, on the other hand, comprises a first boundary wall 24 that is formed by a portion of a luggage compartment housing back wall 26. A second boundary wall 28 of the first air duct portion 14 is formed by a portion of a personal service duct 30 that lies opposite the luggage compartment housing back wall portion forming the first boundary wall 24 of the first air duct portion 14. The personal service duct 30 is used to receive components such as for example an individual air supply device, reading lamps, loudspeakers, oxygen masks and the like. Both the personal service duct 30 and the luggage compartment housing back wall 26 take the form of honeycomb components. This has the advantage that these two components then already possess an insulating function, thereby making it possible to dispense with the provision of additional insulating elements in the region of the first air duct portion 14.

The luggage compartment housing back wall portion forming the first boundary wall 24 of the first air duct portion 14 and the personal service duct portion forming the second boundary wall 28 of the first air duct portion 14 have a geometry that enables a desired guidance of the air stream conveyed through the first air duct portion 14. In particular, these two components are shaped in such a way that the air exiting from the air outlet 20 of the air duct 12 is conveyed in such a way in the direction of a closed luggage compartment flap 32 that the air stream is positioned next to the luggage compartment flap 32, i.e. flows along the luggage compartment flap 32. This allows a draught-free supply of air to passengers situated in the aircraft cabin.

By virtue of the integrated construction of the first air duct portion 14 with the luggage compartment housing back wall portion forming the first boundary wall 24 of the first air duct portion 14 and with the personal service duct portion forming the second boundary wall 28 of the first air duct portion 14, the first air duct portion 14 and in particular the air outlet 20 may be realized with a cross section of flow that is large enough to allow a required air volume flow to be supplied into the passenger cabin at an air injection speed that is comfortable for the passengers and without increased noise generation.

A third boundary wall 34 of the first air duct portion 14 is formed by a first covering cap, which bridges a gap between the luggage compartment housing back wall portion forming the first boundary wall 24 of the first air duct portion 14 and the personal service duct portion forming the second boundary wall 28 of the first air duct portion 14 and is sealingly connected to the luggage compartment housing back wall portion forming the first boundary wall 24 of the first air duct portion 14 and to the personal service duct portion forming the second boundary wall 28 of the first air duct portion 14.

In a similar manner, a fourth boundary wall 36 of the first air duct portion 14 is formed by a second covering cap, which bridges a gap between the luggage compartment housing back wall portion forming the first boundary wall 24 of the first air duct portion 14 and the personal service duct portion forming the second boundary wall 28 of the first air duct portion 14 and is sealingly connected to the luggage compartment housing back wall portion forming the first boundary wall 24 of the first air duct portion 14 and to the personal service duct portion forming the second boundary wall 28 of the first air duct portion 14.

The air guide element 22 forming the second portion 16 of the air duct 12 is provided in the region of the air inlet 18 with an air inlet connecting piece that may be connected in a simple and convenient manner to the line system of the aircraft air conditioning system. The air guide element 22 is further fastened to the luggage compartment housing back wall 26 and may therefore be preassembled with the luggage compartment housing back wall 26 into a subassembly that may be handled independently. There is therefore no need to fasten the air guide element 22 separately to an aircraft structure.

Disposed in the first portion 14 of the air duct 12 is a flow control element 38 for controlling the air flow exiting from the air outlet 20 of the air duct 12. The flow control element 38 comprises an aperture 40 as well as a plurality of guide vanes 42 that extend, in relation to the direction of flow of the conditioned air flowing through the air duct 12, downstream of the aperture 40. The aperture 40 effects a holdup of the air flowing through the air duct 12. The guide vanes 42, on the other hand, straighten out the air flow in the air duct 12. The guide vanes 42 are shaped in such a way and arranged such a small distance apart from one another that they serve as protection against intrusion into the air outlet 20 of the air duct 12. To minimize any risk of injury the guide vanes 42 are provided with neither sharp edges nor sharp corners.

The air supply device 10 further comprises a masking element 44 that is disposed in the region of the air outlet 20 of the air duct 12. The masking element 44 takes the form of a honeycomb panel and is provided with an opening 46, the shape and size of which are adapted to a cross section of the air outlet 20 of the air duct 12. The masking element 44 is fastened detachably to a flange 48 formed on the flow control element 38. Where desirable or necessary, for example in the context of a reconfiguration of the aircraft cabin, the masking element 44 may easily be removed from its position and replaced for example by a masking element without an opening. If in the context of a reconfiguration of the aircraft cabin the air outlet 20 of the air duct 12 is to be closed, it is also possible to remove the air guide element 22 in order additionally to save weight.

1. Air supply device (10) for supplying conditioned air into an aircraft passenger cabin, comprising:
an air duct (12) with an air inlet (18), which is connectable to a line system of an aircraft air conditioning system in order to supply conditioned air provided by the aircraft air conditioning system to the air duct (12), and with an air outlet (20), which is connectable to an interior of the aircraft passenger cabin in order to convey the conditioned air supplied to the air duct (12) by the aircraft air conditioning system into the interior of the aircraft passenger cabin,
characterized in that in at least a first portion (14) of the air duct (12) a first boundary wall (24) of the air duct (12) is formed by a portion of a luggage compartment housing back wall (26).

2. Air supply device according to claim 1,
characterized in that in the first portion (14) of the air duct (12) a second boundary wall (28) of the air duct (12) is formed by a portion of a personal service duct (30) that lies opposite the portion of the luggage compartment housing back wall (26).

3. Air supply device according to claim 1,
characterized in that in the first portion (14) of the air duct (12) a third boundary wall (34) of the air duct (12) is formed by a first covering cap that extends substantially at right angles to the portion of the luggage compartment housing back wall (26).

4. Air supply device according to claim 1,
characterized in that in the first portion (14) of the air duct (12) a fourth boundary wall (36) of the air duct (12) is formed by a second covering cap that extends substantially at right angles to the portion of the luggage compartment housing back wall (26).

5. Air supply device according to claim 1,
characterized in that the air duct (12) in a second portion (16) is formed by an air guide element (22) that is fastened to the luggage compartment housing back wall (26).

6. Air supply device according to claim 5,
characterized in that the second portion (16) of the air duct (12) is disposed, in relation to the direction of flow of the conditioned air flowing through the air duct (12), upstream of the first portion (14) of the air duct (12).

7. Air supply device according to claim 1,
characterized in that in the first portion (14) of the air duct (12) a flow control element (38) is disposed.

8. Air supply device according to claim 7,
characterized in that the flow control element (38) comprises an aperture (40) as well as guide vanes (42) that extend, in relation to the direction of flow of the conditioned air flowing through the air duct (12), downstream of the aperture (40).

9. Air supply device according to claim 8,
characterized in that the guide vanes (42) are shaped and mutually spaced apart in such a way that they serve as protection against intrusion into the air outlet (20) of the air duct (12).

10. Air supply device according to claim 1,
characterized by a masking element (44), which is disposed in the region of the air outlet (20) of the air duct (12) and in which an opening (46) is formed, the shape and size of which are adapted to a cross section of the air outlet (20) of the air duct (12).

11. Air supply device according to claim 2,
characterized in that in the first portion (14) of the air duct (12) a third boundary wall (34) of the air duct (12) is formed by a first covering cap that extends substantially at right angles to the portion of the luggage compartment housing back wall (26).

12. Air supply device according to claim 2,
characterized in that in the first portion (14) of the air duct (12) a fourth boundary wall (36) of the air duct (12) is formed by a second covering cap that extends substantially at right angles to the portion of the luggage compartment housing back wall (26).

13. Air supply device according to claim 2,
characterized in that the air duct (12) in a second portion (16) is formed by an air guide element (22) that is fastened to the luggage compartment housing back wall (26).

14. Air supply device according to claim 1, characterized in that:
in the first portion (14) of the air duct (12) a second boundary wall (28) of the air duct (12) is formed by a portion of a personal service duct (30) that lies opposite the portion of the luggage compartment housing back wall (26);
in the first portion (14) of the air duct (12) a third boundary wall (34) of the air duct (12) is formed by a first covering cap that extends substantially at right angles to the portion of the luggage compartment housing back wall (26);
in the first portion (14) of the air duct (12) a fourth boundary wall (36) of the air duct (12) is formed by a second covering cap that extends substantially at right angles to the portion of the luggage compartment housing back wall (26);
the air duct (12) in a second portion (16) is formed by an air guide element (22) that is fastened to the luggage compartment housing back wall (26).

15. Air supply device according to claim 2,
characterized in that in the first portion (14) of the air duct (12) a flow control element (38) is disposed.

16. Air supply device according to claim 3,
characterized in that in the first portion (14) of the air duct (12) a flow control element (38) is disposed.

17. Air supply device according to claim 2,
characterized by a masking element (44), which is disposed in the region of the air outlet (20) of the air duct (12) and in which an opening (46) is formed, the shape and size of which are adapted to a cross section of the air outlet (20) of the air duct (12).

18. Air supply device according to claim 3,
characterized by a masking element (44), which is disposed in the region of the air outlet (20) of the air duct (12) and in which an opening (46) is formed, the shape and size of which are adapted to a cross section of the air outlet (20) of the air duct (12).

19. Air supply device according to claim 9,
characterized by a masking element (44), which is disposed in the region of the air outlet (20) of the air duct (12) and in which an opening (46) is formed, the shape and size of which are adapted to a cross section of the air outlet (20) of the air duct (12).
